(19) United States
(12) Patent Application Publication
(10) Pub. No.: US 2018/0124536 A1
(43) Pub. Date: May 3, 2018

(54) VISUAL INDICATOR FOR EXISTING MICROPHONE STANDS AND BOOMS

(71) Applicant: Michael Namon Lee Gay, Mableton, GA (US)

(72) Inventor: Michael Namon Lee Gay, Mableton, GA (US)

(21) Appl. No.: 15/798,347

(22) Filed: Oct. 30, 2017

Related U.S. Application Data
(63) Continuation of application No. 62/415,719, filed on Nov. 1, 2016.

(51) Int. Cl. H04R 29/00; H04R 1/08; F21V 19/00

(52) U.S. Cl. CPC H04R 29/008; H04R 29/004; F21Y 2115/10; F21V 19/001; H04R 1/08

(57) ABSTRACT

The present invention comprises a novel visual indicator that is capable of being installed on a standard microphone stand or boom with no interference to the normal operation of the microphone stand or boom. Standard microphone stands and booms that do not have a visual indicator built in can make use of this invention by adding visual signaling functionality to an existing microphone stand or boom.

### CROSS REFERENCE TO RELATED APPLICATIONS

This application claims the benefit of provisional patent application No. 62/415,719, filed 2016 Nov. 1 by the present inventor.

### BACKGROUND

### Field

This application relates to visual indicators, specifically to such visual indicators used in broadcast studios, recording studios, or live sound facilities.

### Prior Art

In the field of audio recording and broadcasting, the user of a microphone may wish to receive visual indications of messages from an audio control operator to the microphone user. These messages could include, but are not limited to, messages such as “start talking now,” or “the microphone is now on the air live,” or “there are ten seconds left in this segment.” Currently, these visual indications to a microphone operator may be provided by several means. Among these existing means are hand signals (if the operator is in visual range), lights mounted on an audio console, table, or turret near the operator, scrolling LED displays, text or graphic indications on a computer screen, or even a visual indicator permanently built into a microphone boom. It is customary for the operator and the microphone user to agree upon ahead of time what message a particular visual indication state represents. Examples of visual indication states in the current art may include hand signals, indicator light colors, or an indicator light's rate of flash.

The microphone user may also wish to know the operating state of a piece of equipment such as knowing that his microphone is turned on, knowing his microphone audio is being used in another studio, or even being alerted to a silence detected in the audio feed to a broadcast transmitter. The visual indications can be controlled by an interface to the equipment to provide visual indications of the equipment operating state.

Many visual indicators used in a broadcast or recording require the operator to look away from the microphone potentially compromising the quality of the audio picked up by the microphone.

Certain microphone booms have been manufactured with visual indicators permanently built in to the structure of the boom to allow the operator to remain looking, and in the direction of the microphone. These devices provide only a one or two color indication to the microphone operator of a message or operating state.

Most of these existing devices are not removable and cannot be added to existing microphone booms. The devices that can be added to an existing microphone boom are limited to a given manufacturer's proprietary mounting system that limits use of their device to microphone booms manufactured by the same manufacturer.

None of the prior solutions address microphone stands, which are much more portable in nature and have more wide ranging use applications than the broadcast or recording studio. Microphone stands are utilized outside the recording studio in live sound applications as well as public address applications. There may be a desire to add visual indication capabilities in these applications as well.

To take advantage of the capabilities of microphone booms with permanent visual indicators, an installer must completely replace any existing booms in a broadcast or recording studio that he wishes to have the indicator capability. Furthermore, these microphone booms may not be available in a shape or size suitable to the particular studio, making it difficult or impractical to use, depending on the circumstances.

Therefore, a need exists in the field for a novel device capable of adding visual indication capability to the millions of existing microphone booms in recording studios and/or broadcast studios. This capability is needed for microphone stands as well. A further need exists to provide a wider variety of indications such as a wider variety of colors of illuminations and/or a wider variety of flash patterns for the illumination.

### SUMMARY

The present invention relates to a visual indicator that is added to microphone stands and booms. The invention provides indication to the microphone user of at least one operator message or equipment operating state, but in particular a plurality of different messages or equipment operating states. The invention contains at least one colored light source in the invention but will typically contain multicolored light sources to allow use of various colors to signify specific various corresponding messages or operating states. More particularly, the invention relates to a device capable of being added to, and later removed from, an existing microphone stand or boom without interference to the normal operation of said microphone stand or boom.

### BRIEF DESCRIPTION OF THE INVENTION

The present invention consists of a device capable of being added to most types of conventional microphone stands or microphone booms from most manufacturers without modification of the stand or boom. The device is designed in such a manner that it will not interfere with the normal operation of the microphone stand or microphone boom or the microphone. To install the device, a person of ordinary skill in the art would remove an existing microphone mounted to the boom by unscrewing the microphone mount, adding the invention to the stand or boom by screwing it onto the existing microphone stand or boom, and then reinstalling the microphone by screwing its mount onto the invention. The installer would then install any needed power and control wires to the invention in a means similar to that of installing the existing audio cable to the microphone.

### DRAWINGS-FIGURES

Some embodiments of the present invention are illustrated as an example and are not limited by the figure of accompanying drawings, in which like references may indicate similar elements in which:

FIG. 1 depicts a side view of one example of a visual indicator for existing microphone stands and booms according to various embodiments of the present invention.

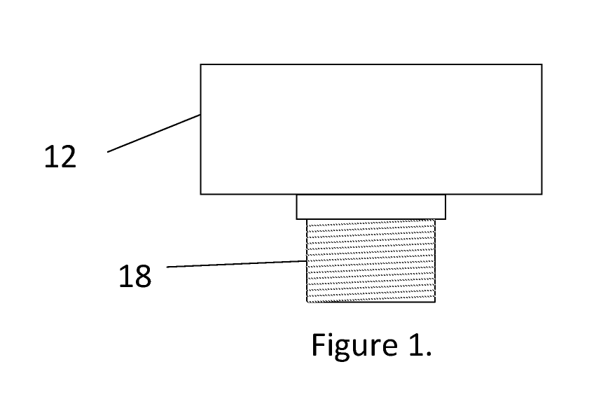

FIG. 2 depicts a top view of one example of a visual indicator for existing microphone stands and booms according to various embodiments of the present invention.

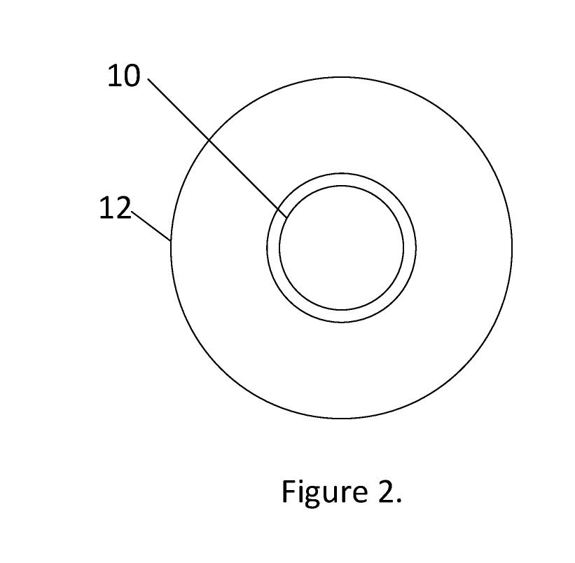

FIG. 3 depicts a side cutaway view of one example of a visual indicator for existing microphone stands and booms according to various embodiments of the present invention.

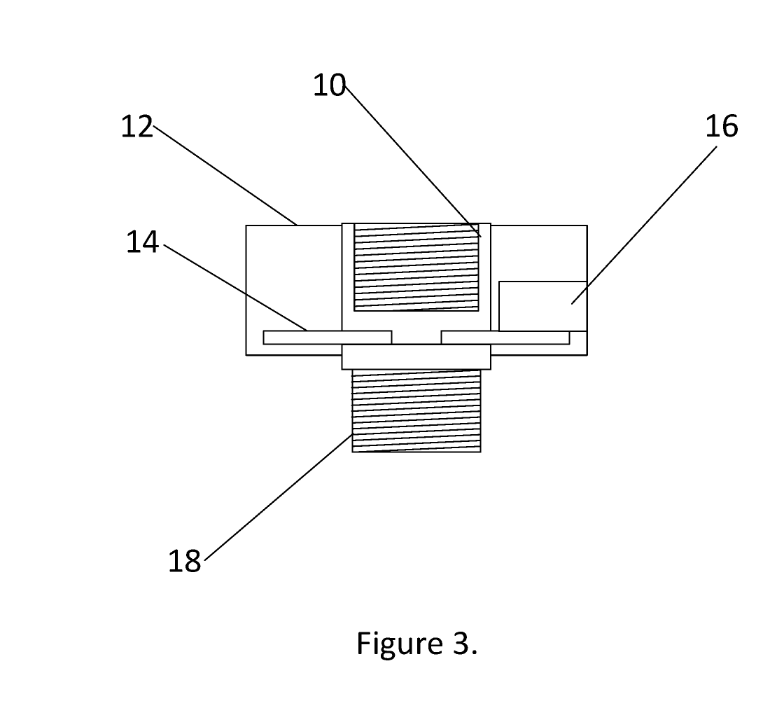

FIG. 4 depicts an exploded view of an example installation of a visual indicator for existing microphone stands and booms according to various embodiments of the present invention.

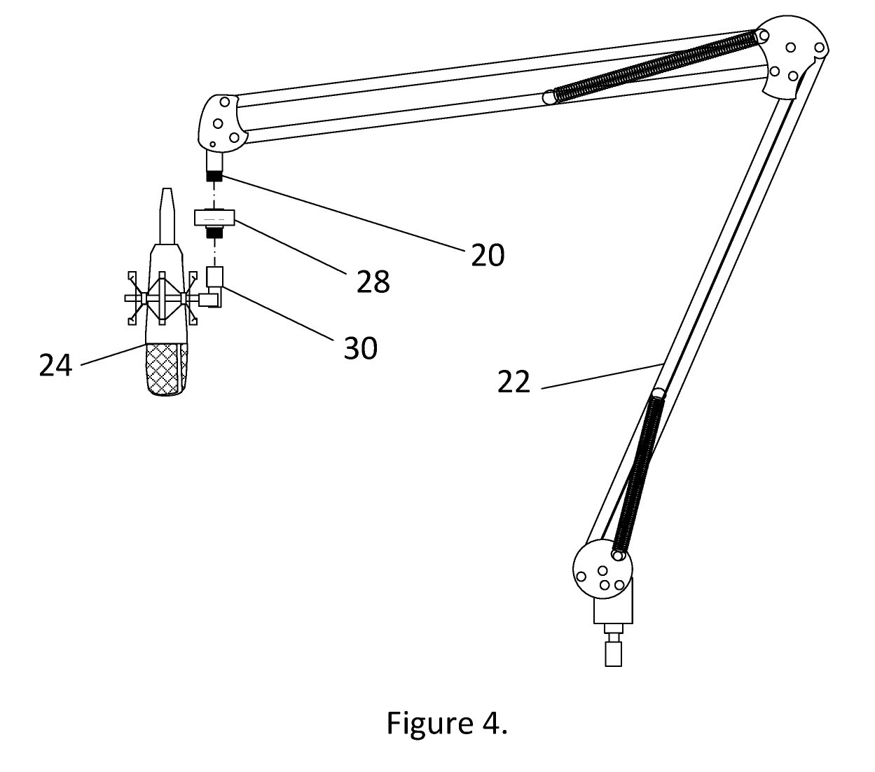

FIG. 5 depicts an exploded view of an example installation of a visual indicator for existing microphone stands and booms according to various embodiments of the present invention.

Reference numerals for drawings: 10 upper structural core 12 semi translucent diffusion material 14 light source circuit board 16 connector 18 lower structural core 20 threaded connector on typical microphone boom 22 typical microphone boom 24 typical broadcast microphone 26 power and control wire 28 one embodiment of the invention 30 typical microphone mount

### DETAILED DESCRIPTION OF THE INVENTION

The invention is comprised of the following:

The Upper Structural Core 10—The upper structural core is the part that connects the device to a microphone stand or boom. This core contains a threaded female connector using threading corresponding to an industry standard microphone boom threading.

The Diffusion Material 12—This material diffuses the light source and encapsulates and protects the light source electronics on the circuit board 14. The diffusion material is typically made of cast or injected semi-translucent plastic. The material may be any color but white is preferred if the light source is capable of multiple colors.

The Light Source 14—Typically mounted on a circuit board, the light source 14 can be a single light emitting device or array of individually addressable light emitting devices such as LED, OLED, Electro Luminescent, Incandescent, or other light emitting devices. The light source 14 may be capable of producing multiple colors of light or, if preferred, limited to one color of light.

The Connector 16—Allows multi-conductor wire to be connected to the device to provide power and control of the light source.

The Lower Structural Core 18—The lower structural core is the part that allows connection of a microphone mount to the device. This core contains a threaded male connector using threading corresponding to an industry standard microphone mount threading.

The screw threading on the upper structural core 10 is sized and threaded to match the threading on standard microphone stands or booms. This threading is 5/16″—27 in the United States but may follow other standards internationally. This matched threading allows the device to be installed where a microphone mount would normally be installed on a microphone stand or boom.

The screw threading on the lower structural core 18 is sized and threaded to match standard microphone mounts that would normally connect to a microphone stand or boom. This threading is 5/16″—27 in the United States but may follow other standards internationally. This threading allows a microphone mount to be installed on the device. This is a key feature of the device making it possible to add this device universally to any existing microphone stand or boom without interference to the normal operation of said stand or boom.

Another embodiment of the invention may use threading to match the standard for the country of use or to match the threading of a microphone stand or boom that varies from accepted standards.

Another embodiment of the invention may use thread adapters to match the standard for the country of use or to match the threading of a microphone stand or boom that varies from accepted standards.

Low voltage electrical power and control signals are fed through a control wire 26 into the connector. The control signals themselves are designed to interface with the specific onboard electronics. The present embodiment of invention uses shift register logic to load data into each individual programmable element in the light array to program its state and color.

Another embodiment of the invention might use discreet pulse width modulation signals, which may also be used to create the desired color in the multicolor light array as well. An embodiment for single color applications may not require any signals other than a flow of electricity to activate the light source of the invention.

One embodiment of the invention is made by press fitting the upper structural core 10 into the diffusion material 12. The diffusion material may be manufactured using standard plastic injection molding process or resin casting processes. A circuit board containing the light source 14 electronics is then inserted into a recess in the diffusion material. The lower structural core 18 is then bonded to the upper structural core, sandwiching the circuit board between.

To use the invention, a person with normal skill in the art of audio systems setup and installation would first remove any existing microphone mount and microphone that may be attached to a typical microphone stand or boom 22. The invention would then be attached to the mating threaded connector 20 on said microphone stand or boom 22. The said microphone mount 30 containing the microphone 24 would then be attached to the mating threaded connector on the invention 18. Finally, the wire containing electrical power and control signals would be connected to the connector 16 on the invention with the other end of the wire connected to the source of the power and control signal.

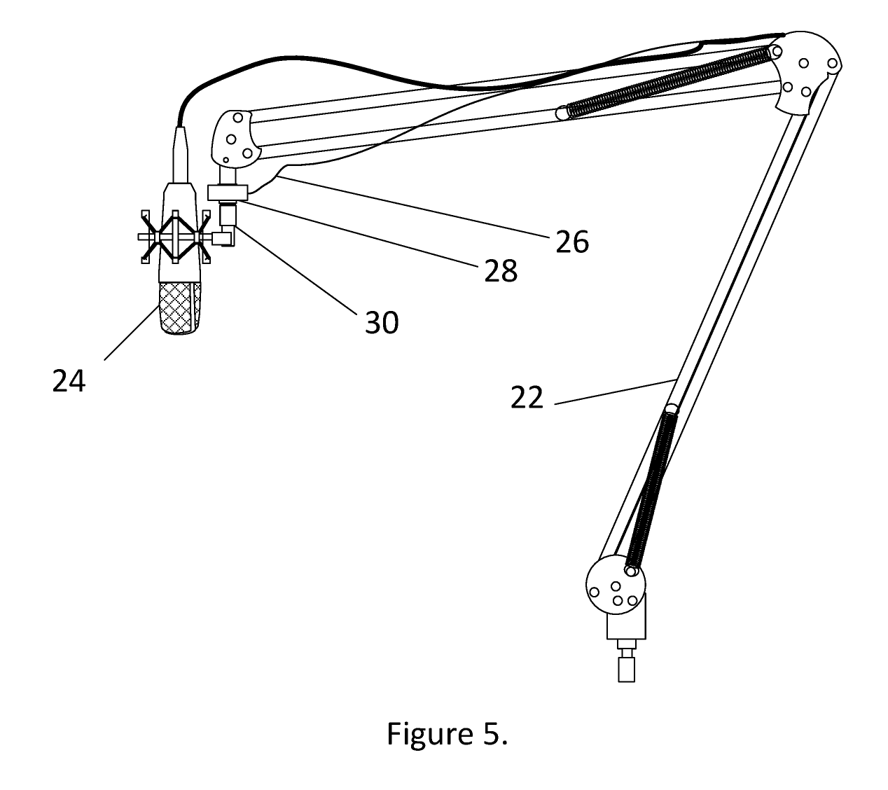

FIG. 5 depicts the invention 28 installed on a typical microphone boom 22. A typical microphone mount 30 containing a typical microphone 24 is then mounted to the invention. The power and control wire 26 is then routed from the connecter on the invention to the source of power and control.

### ADVANTAGES OF THE INVENTION

From the description above, a number of advantages of some embodiments of my invention become evident:

Millions of microphone booms are already installed in broadcast and recording studios. The invention adds visual signaling capability to these installed microphone booms and stands that otherwise would require replacement.

The invention adds visual signaling capability to the millions of existing microphone stands used in broadcast and recording studios, live sound applications, and public address applications.

A microphone operator would not be required to look away from a microphone to see a visual indicator if it is in close proximity to the microphone. While prior art may address this advantage, the invention expands the capability to any standard microphone stand or boom.

### CONCLUSION

Although the description above contains many specificities, these should not be construed as limiting the scope of the embodiments but as merely providing illustration of the presently preferred embodiment. For example, the diffusion material could have other shapes such as triangular, oval, pentagonal, etc.; the diffusion material could be designed in the shape of a company logo; the diffusion material could be completely omitted; the threading of the structural cores could be changed to other standards.

Thus the scope of the embodiments should be determined by the claims and their legal equivalents, rather than the examples given.

Having described my invention what I claim is new and desire to secure by letters patent is:

1. A visual signaling apparatus for use by an operator, comprising:
a threaded female connector;
a light source borne by an enclosure for emitting light; and
a threaded male connector
wherein said light source is attached to said female connector;
wherein said male connector is attached to said light source;
wherein said threaded female connector comprises a threading corresponding, to an industry standard microphone boom mount threading;
wherein said male connector comprises a threading; corresponding to an industry standard microphone mount threading;
whereby said apparatus may be installed between said microphone mount and said microphone stand or boom.

2. A visual signaling apparatus according to claim 1, wherein said fight source may be controlled by an external control circuit.

3. A visual signaling apparatus according to claim 1, wherein said light source may be selectively activated.

4. A visual signaling apparatus according to claim 1, wherein said light source may selectively produce specific wavelengths of light.

5. A visual signaling apparatus according to claim 1, wherein said light source may selectively produce animated patterns of light.
